(19) United States
(12) Patent Application Publication
(10) Pub. No.: US 2018/0041461 A1
(43) Pub. Date: Feb. 8, 2018

(54) ONE-TO-MANY ICEBREAKER POST GENERATING REAL-TIME PRIVATE ONE-ON-ONE CHAT THREADS

(71) Applicant: Foundermark, Inc., Manasquan, NJ (US)

(72) Inventor: Daniel Ramesh Kurani, Manasquan, NJ (US)

(73) Assignee: Foundermark, Inc., Manasquan, NJ (US)

(21) Appl. No.: 15/669,116

(22) Filed: Aug. 4, 2017

Related U.S. Application Data
(60) Provisional application No. 62/370,906, filed on Aug. 4, 2016.

(51) Int. Cl. H04L 12/58; G06Q 50/00

(52) U.S. Cl. CPC H04L 51/32; G06Q 50/01; H04L 51/08; H04L 51/10; H04L 51/04

(57) ABSTRACT

Embodiments include providing an icebreaker message that may be broadcast publicly by a poster to users of a social media application. The icebreaker message may be structured and context-based. The icebreaker message may be routed to different users based on one or more variables. A user may reply directly to the icebreaker message, and the reply may not be visible to other user. The reply may be sent to the poster and a private one-on-one chat between the poster and the user may be initiated. Different users may be individually connected to the poster in real-time in private one-on-one chat threads by replying directly to the icebreaker message.

### CROSS REFERENCE TO RELATED APPLICATIONS

This application claims the benefit of U.S. Provisional Application No. 62/370,906 filed on Aug. 4, 2016, the content of which is hereby incorporated by reference herein.

### BACKGROUND

Embodiments described herein relate to social networks, and more particularly to a method, system and computer program product for organizing social network messages based on user response to a one-to-many icebreaker post.

Online social networks are a universal mechanism to connect people and information in logical and organized ways which enable sharing and processing of information between the members of the social network. Common mechanisms for sharing and processing information on online social networks may include, but are not necessarily limited to: a wall or virtual wall where users or member of the social network can post messages for other users or members; an activity stream, which may be a list of messages or posts received by a user or member and may also include a list of messages or posts sent by the user or member; a timeline that may chronologically list a series of events; and profiles of users or members that can be accessed for information about a particular user or member. These mechanisms enable users or members to rapidly share information with others and gather information from others in the network.

### SUMMARY

Methods, systems, and apparatuses for organizing messages in a social media application are described herein. Embodiments include receiving an icebreaker message from a poster. The icebreaker message may be broadcast to a plurality of users of the social media application. A reply to the icebreaker message may be received from a first user of the plurality of users. The reply is made directly to the icebreaker message and is not visible to the remaining plurality of users. The reply may be sent to the poster. A private one-on-one chat thread between the poster and the first user may be initialized.

### BRIEF DESCRIPTION OF THE DRAWINGS

A more detailed understanding may be had from the following description, given by way of example in conjunction with the accompanying drawings wherein:

FIG. 1 is a flowchart illustrating a method for organizing private one-on-one social network messages based on user response to a one-to-many icebreaker post;

FIGS. 2A-2H are diagrams illustrating a graphical user interface (GUI) that may be displayed to the poster during the posting of the icebreaker message;

FIGS. 3A-3B are diagrams illustrating a GUI that may be displayed to one or more users viewing an icebreaker message;

FIGS. 4A-4B are diagrams illustrating GUI that may be displayed to the poster after receiving one or more replies to an icebreaker message;

FIG. 5 is a block diagram illustrating the creation of private one-on-one chat threads based on replies to a public icebreaker message; and

FIG. 6 is a block schematic diagram of a system configured for organizing messages based on user response to a one-to-many icebreaker post.

### DETAILED DESCRIPTION

Embodiments described herein may include a system, as method, and/or as computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating, electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Embodiments are described herein with reference to flowchart illustrations and/or block diagrams of methods, apparatuses, systems, and computer program products. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a general purpose computer, special purpose computer, or other programmable data processing apparatus to produce a machine, such that the instructions, when executed by the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner. Accordingly, the computer readable storage medium having instructions stored therein may be an article of manufacture including instructions whish implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions when executed by the computer, other programmable apparatus, or other device implement the functions/acts specified the flowchart and/or block diagram block or blocks.

Embodiments include providing an icebreaker message that may be broadcast publicly by a poster to users of a social media application. The icebreaker message may be structured and context-based. The icebreaker message may be routed to different users based on one or more variables. A user may reply directly to the icebreaker message, and the reply may not be visible to other user. The reply may be sent to the poster and a private one-on-one chat between the poster and the user may be initiated. Different users may be individually connected to the poster in real-time in private one-on-one chat threads by replying directly to the icebreaker message.

Unlike conventional social media applications, which may require waiting for a response and reaching out to multiple users multiple times to start multiple conversations, embodiments described herein allow for users to reply directly to a global post in private one-on-one threads. In addition, unlike conventional messaging applications, which require repeated one-to-one outreach to multiple recipients, embodiments described herein provide the ability to broadcast one icebreaker message to a number of recipients. These embodiments make it easier for users to start conversations and, because the one-on-one chat threads are private, may reduce large audience based internet trolling and bullying that is prominent in public comment threads.

The icebreaker message may analyzed for context, based on opinions, values, beliefs, preferences and other personality characteristics of the broadcast, and may be matched to a chosen audience based on one or more variables including, but not exclusive to, recent posts, gender, age, location and preferences. In addition, the combination of replies to structured icebreaker messages may be used to create a social graph of the values, beliefs, opinions, preferences, interests, and personality characteristics.

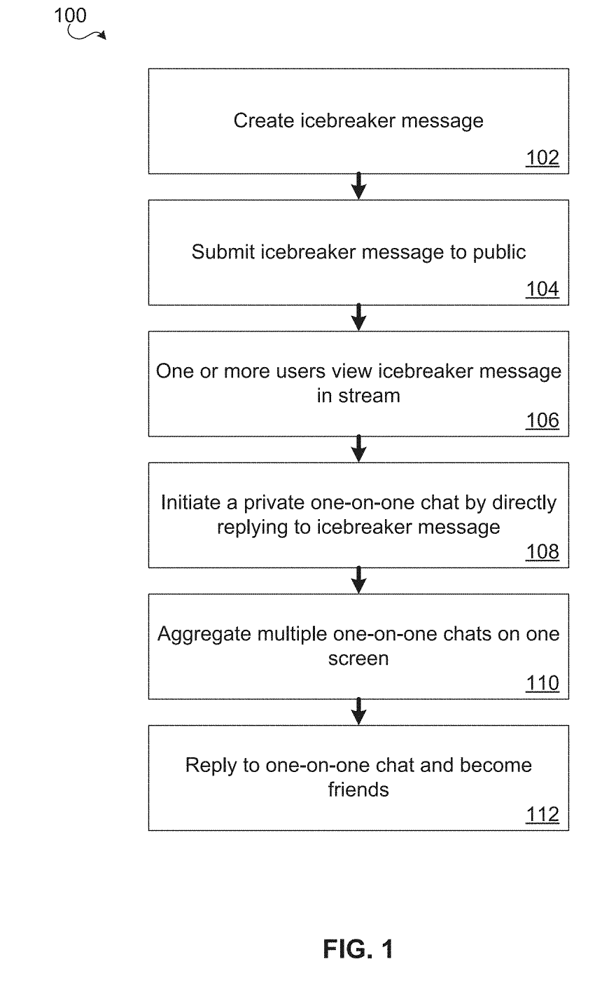

Referring now to FIG. 1, a flowchart illustrating a method 100 for organizing private one-on-one social network messages based on user response to a one-to-many icebreaker post is shown.

In step 102, a poster may create a structured icebreaker message intended to be broadcast to one or more recipients. In an embodiment, the user may type freeform text into a field to create the icebreaker message. In another embodiment, the user may create the icebreaker message by filling in a blank field of a prompt statement selected by the user out of a plurality of prompts. Once the user fills in the blank, the completed statement may be used to generate a question to be used for the icebreaker message. The user may also upload an image from the poster's device to post with the icebreaker message. Additionally or alternatively, the user may select an image out of a plurality of images to post with the icebreaker message. As described in additional detail below, the plurality of prompts and/or the plurality of images may be stored in a file system of a user device or a server that may be accessed over a network.

In step 104, the poster may submit the icebreaker message to be posted publicly to a social network.

In step 106, the icebreaker message may be routed to streams of one or more users. One or more variables may be used to route the post to an appropriate audience. The one or more variables may include timing of the icebreaker message and previous messages, age, gender, and location of the user and the one or more users, and the content of the icebreaker message. The one or more variables may be based on one or more of user behaviors and data collected by the social media application. For example, the one or more variables may be based on a time since the poster and/or the one or more users have posted last. The one or more variables may be based on demographic information of the poster and/or the one or more users. The demographic information may include, for example, age, gender, and location. The one or more variables may be based on psychographic information of the poster and/or the one or more users, such as, for example, a personality test or other indications of person. The reputation of the poster and/or the one or more users (e.g., history of moderation) may be used for the one or more variables. The activity of the poster and/or the one or more users (e.g., posting frequency and engagement level) may be used as the one or more variables.

The one or more variables may be determined by a machine learning process used to analyze past posts from the poster and/or the one or more users. The machine learning process may include natural language processing (NLP) that may recognize certain words or context that the one or more users may respond to based on their history of posting and responding.

The one or more users may see the icebreaker post in their stream. The one or more users may decide to skip the icebreaker post or may reply to it.

In step 108, a one-on-one chat thread may be initiated between the poster and each of the one or more users that reply to the icebreaker message. The one or more users may reply by typing a response in a text field. Additionally or alternatively, the one or more users may reply to the icebreaker message by uploading an image from the user's device or by selecting an image out of a plurality of images. The one-on-one chat thread may be private between the poster and each of the one or more users. The one-on-one chat may be automatically initiated when the one or more users directly reply to the icebreaker post.

In step 110, multiple one-one-chat threads between the poster and the one or more users that replied may be aggregated on one screen and displayed to the poster.

In step 112, the poster may ignore or reply to each of the multiple one-on-one chat threads. The poster may reply to reply to the one-on-one chat by typing a response in a text field. Additionally or alternatively, the poster may reply to the one-on-one chat by uploading an image from the poster's device or by selecting an image out of a plurality of images. After a two-way private conversation is conducted in the one-on-one chat thread, the poster and the one or more users may automatically become friends on the social networking application after a predetermined number of back and forth messages in the one-on-one chat thread. Once the poster and the user are friends, the poster and the user may initiate additional one-on-one private chats with one another directly.

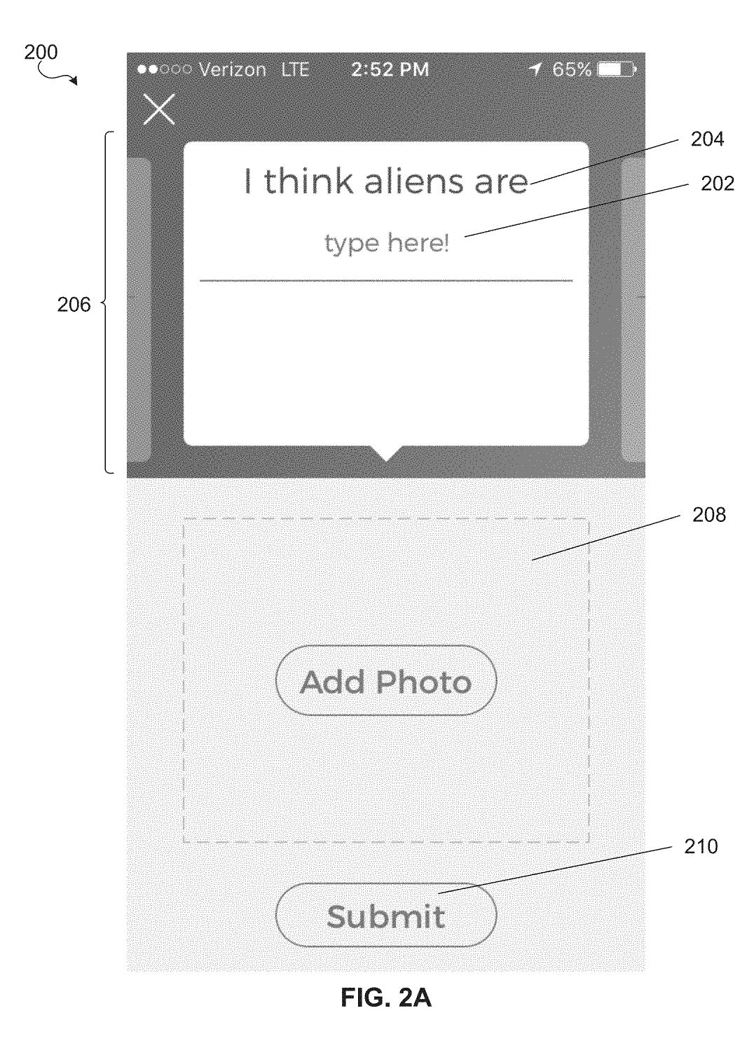

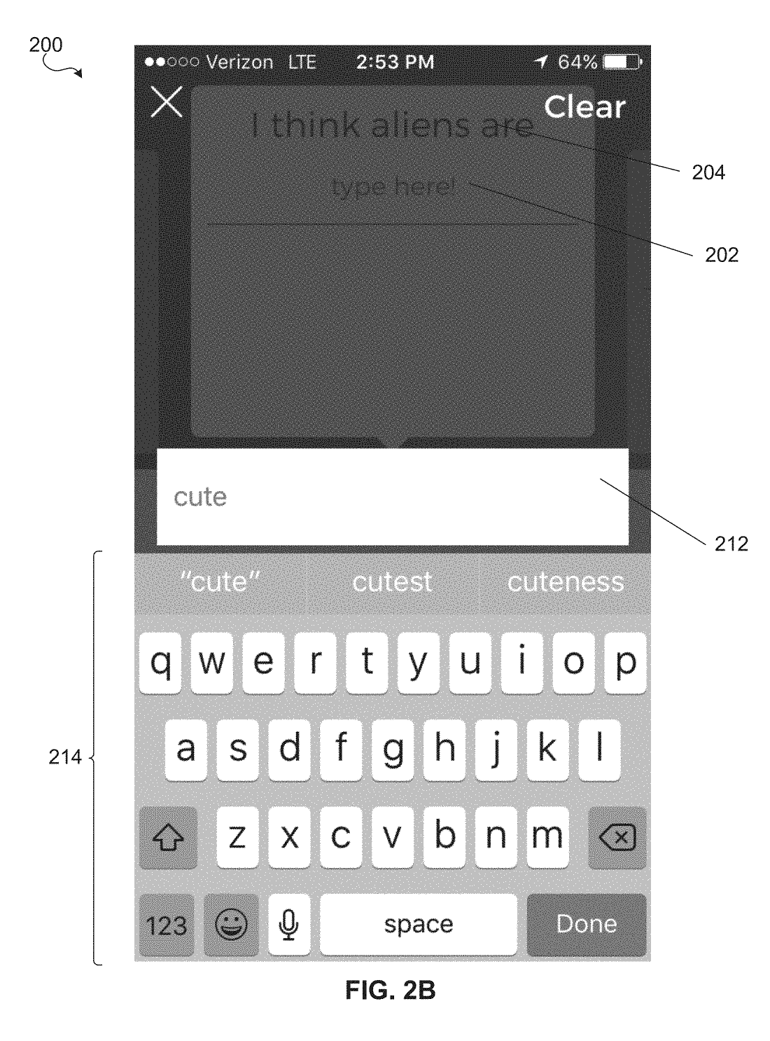

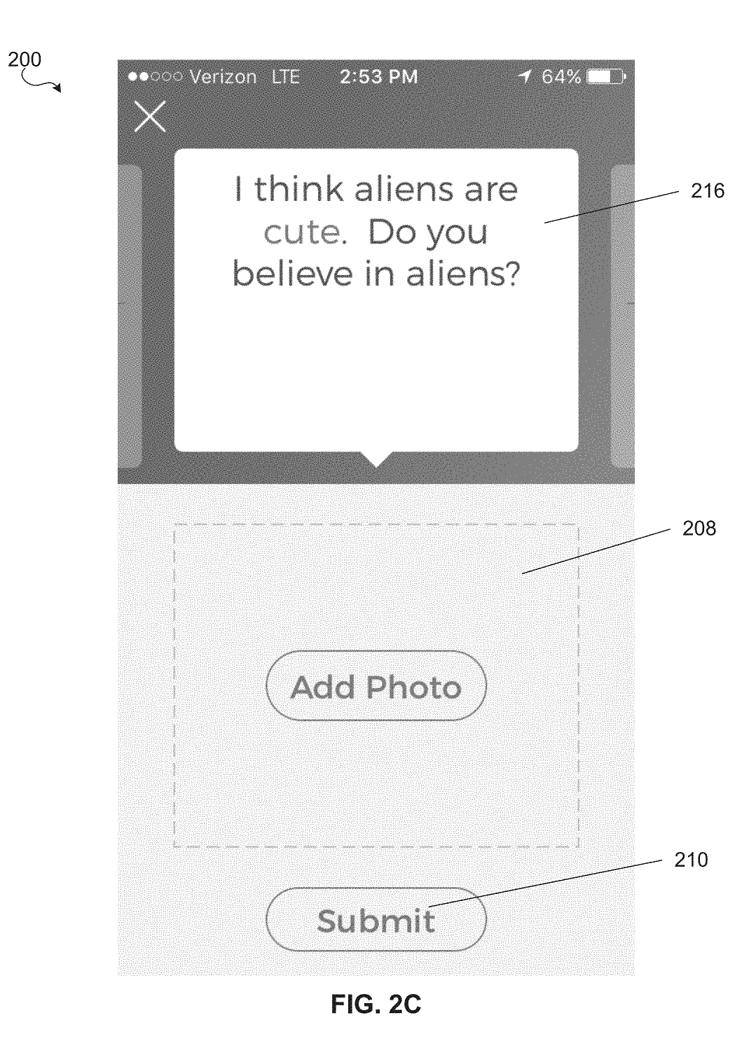

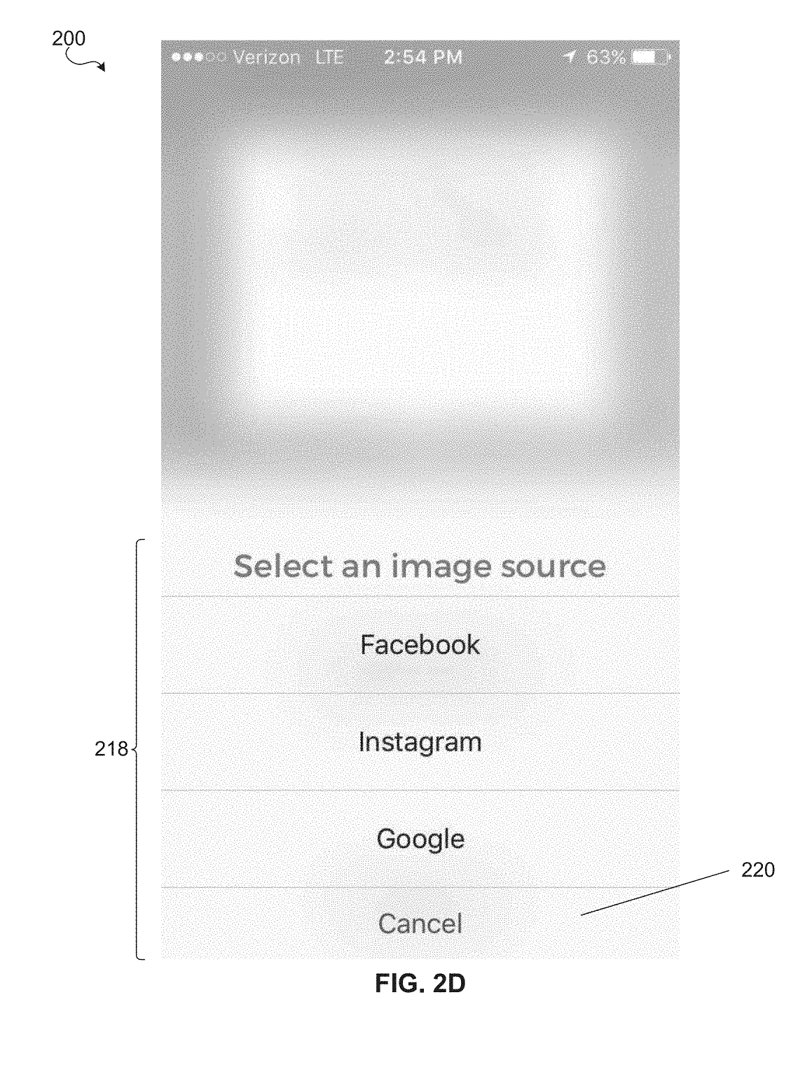

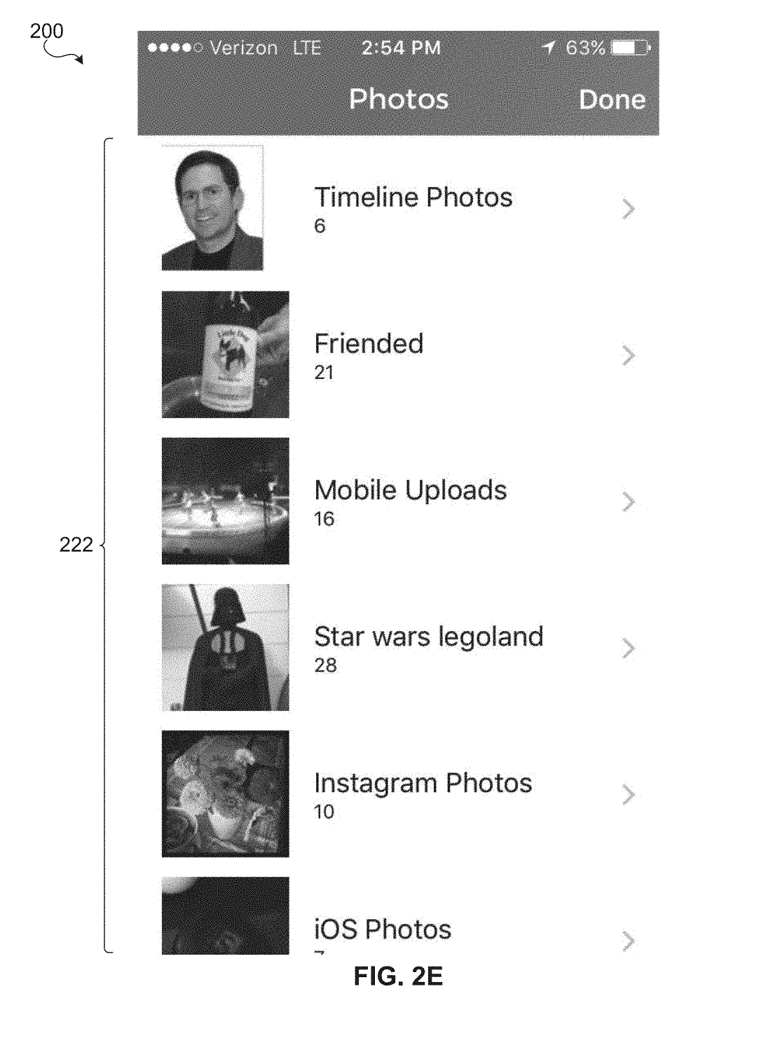

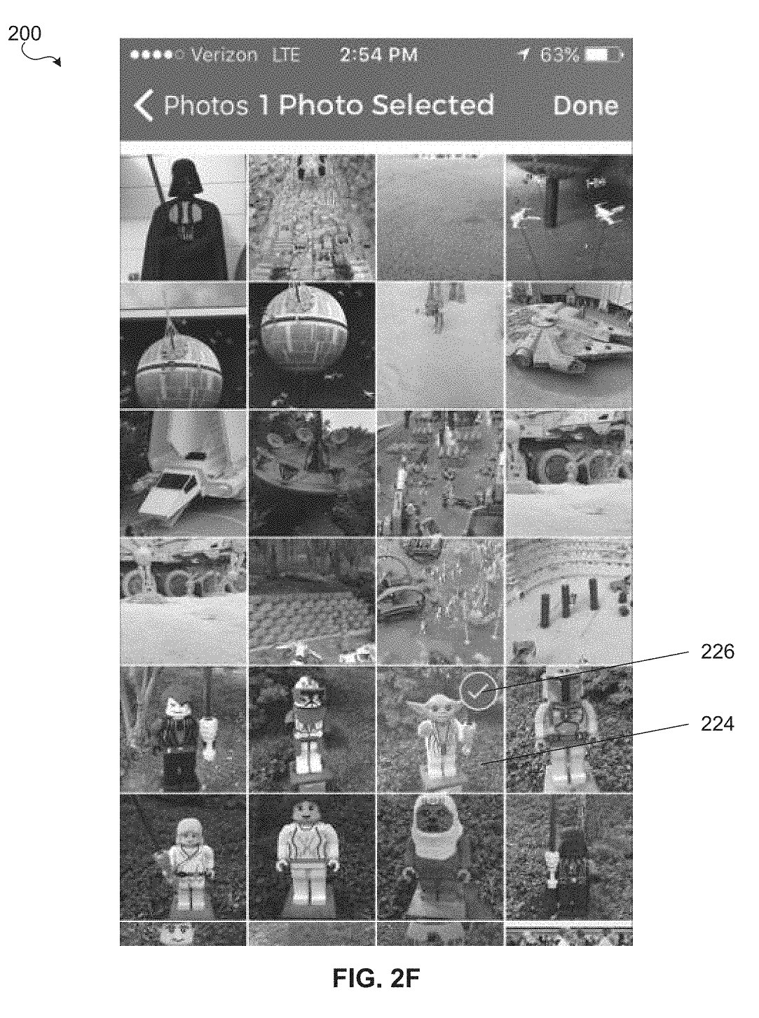

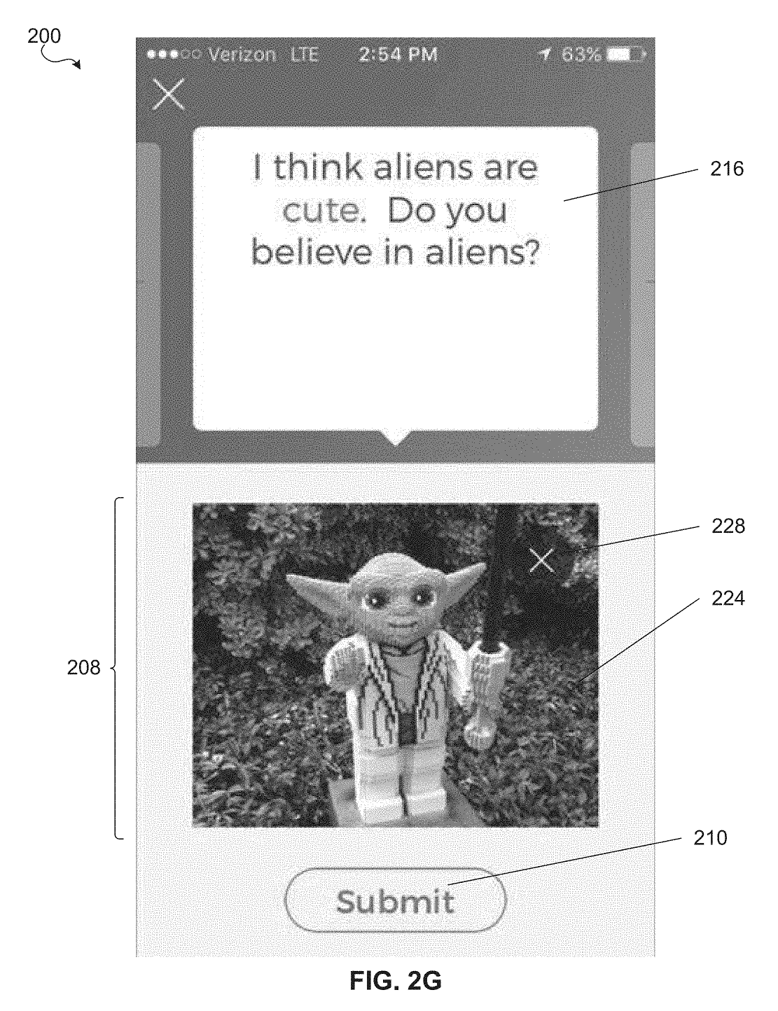

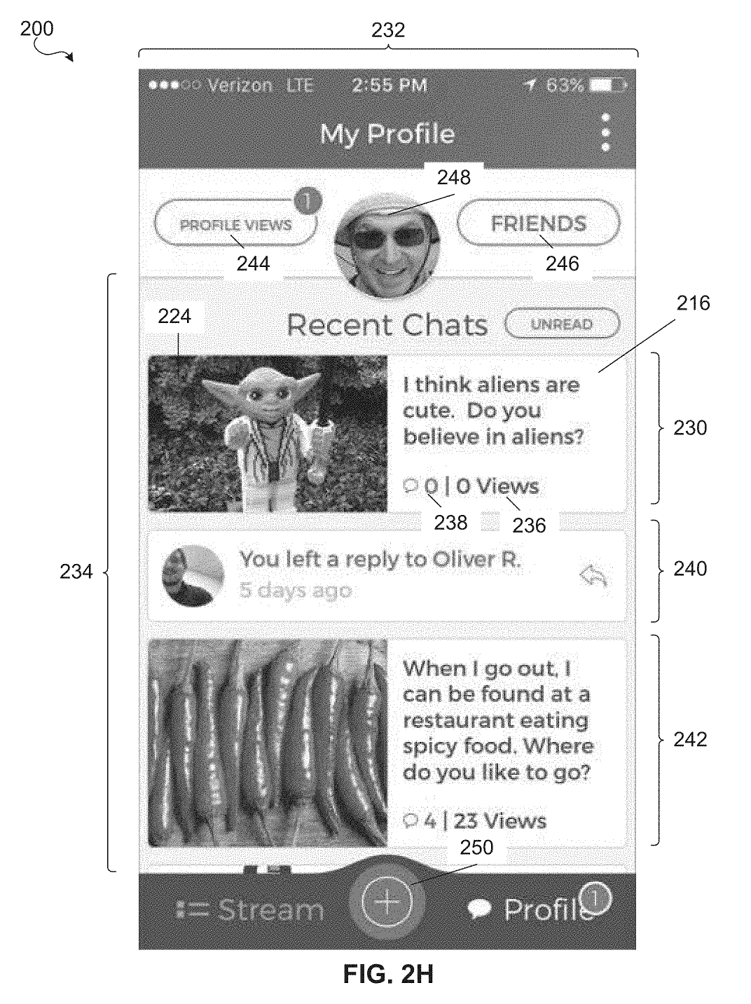

Referring now to FIGS. 2A-2H, diagrams illustrating a graphical user interface (GUI) 200 that may be displayed to the poster during the posting of the icebreaker message is shown. The GUI 200 may be used to execute, at least, step 102 and step 104 as described above with reference to FIG. 1.

FIG. 2A shows a blank field 202 of a prompt statement 204 selected by the user out of a plurality of prompts 206. The plurality of prompts 206 may be curated, edited, created, and removed by an administrator of the social media application.

The GUI 200 may include an area 208 that allows the poster to add a photograph to the icebreaker message. As described above, the image may be uploaded from the poster's device. Additionally or alternatively, the user may select an image out of a plurality of images to post with the icebreaker message. The plurality of prompts 206 and/or the plurality of images may be stored in a file system of a user device or a server that may be accessed over a network. The GUI 200 may also include a submit button 210 that enables the poster to post the icebreaker message.

FIG. 2B shows an input field 212 that allows the poster to enter an input in the blank field 202 of the prompt statement 204. The input field 212 may display any input entered by the poster into an input device 214. As shown in FIG. 2B, the input device 214 may include an on-screen keyboard. The poster may enter any input into the input field 212, including, but not limited to, text, numbers, symbols, emoji, and Graphical Interchange Format (GIF) images. Here, the input is text that reads “cute.”

FIG. 2C shows a completed icebreaker message text 216 after the poster has entered the input “cute” into the input field 212. As described above, once the user provides an input to the input field 212, the completed statement may be used to generate a question to be used for the icebreaker message text 216. Here, the icebreaker message text 216 is “I think aliens are cute. Do you believe in aliens?” After the icebreaker message text 216 is generated, the poster may post the icebreaker message text 216 by clicking the submit button 210. Alternatively, the poster may add an image to the icebreaker message text 216 by clicking on the area 208 to add a photo.

FIG. 2D shows the GUI 200 after the poster clicks on the area 208 to add a photo. An image source selector 218 may be displayed. The image source selector 218 may allow the poster to choose a location or application from which an image may be uploaded to the icebreaker message text 216. Examples of locations that may be displayed in the image source selector 218 include, but are not limited to, social media applications such as Facebook and Instagram, online cloud storage services such as Google Images, and local device folders. The poster may cancel the uploading of images by clicking a cancel button 220 in the image source selector 218.

FIG. 2E shows image folders 222 that the image source selector 218 may access in order to upload an image to the icebreaker message text 216. As described above, the image folders 222 may be associated with social media applications such as Facebook and Instagram, online cloud storage services such as Google Images, and local device folders. The image folders 222 may be located on a user device or on a server and may be accessed through a network.

FIG. 2F shows a selected image 224 of an image folder 222 that may be included in the icebreaker message text 216. The selected image 224 may be indicated by a mark 226. The mark 226 indicating a selected image 224 may be, for example, a checkmark.

FIG. 2G shows the icebreaker message text 216 along with the selected image 224. The selected image 224 may be displayed in the area 208 to add a photo. The poster may remove the selected image 224 from the icebreaker message text 216 by clicking on a remove button 228. The remove button 228 may be, for example, an “X.”

FIG. 2H shows a completed icebreaker message 230 that has been posted publicly. The completed icebreaker message 230 may be shown in in the poster's profile 232. The completed icebreaker message 230 may include the icebreaker message text 216 and the selected image 224. The completed icebreaker message 230 may also include a view counter 236 and a reply indicator 238. The poster's profile 232 may display recent chats 234, which may include the posted completed icebreaker message 230. The recent chats 234 may also show past replies 240 left by the poster and past icebreaker messages 242 posted by the poster. The recent chats 234 may show the latest items at the top, and the entries may move down as time goes by.

The poster's profile 232 may also have profile views link 244 showing which users have viewed the poster's profile. The poster's profile 232 may also have a friends link 246 showing the poster's friends. A thumbnail profile picture 248 of the poster may be included. An add button 250 may allow the poster to create a new icebreaker message.

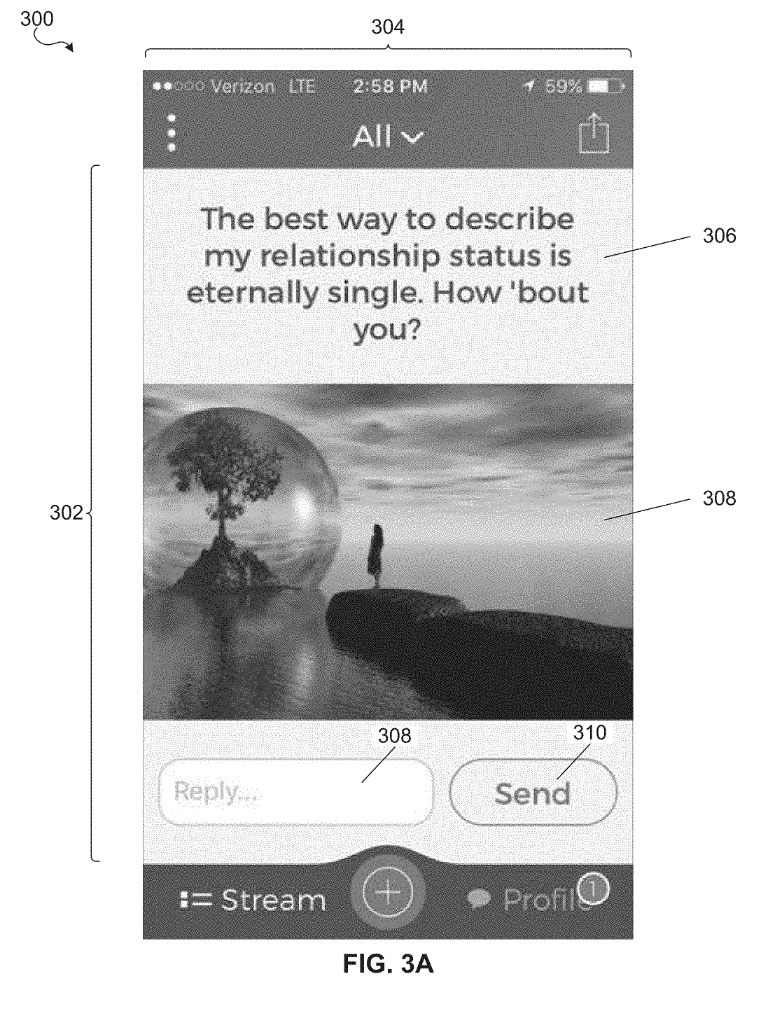

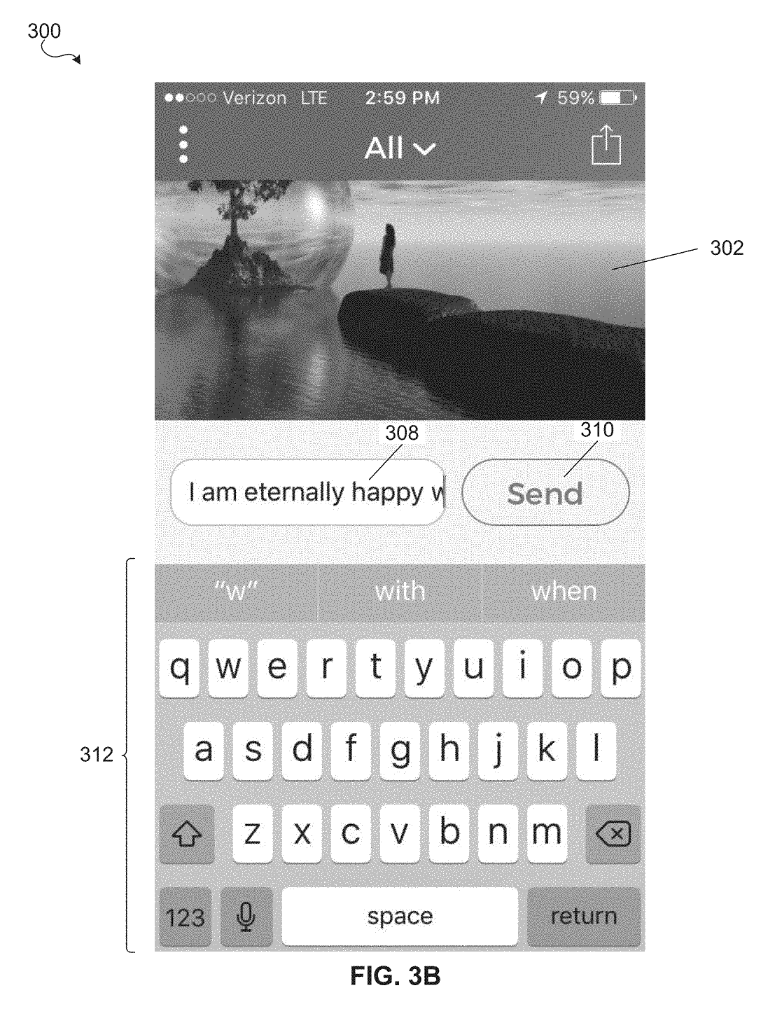

Referring now to FIGS. 3A-3B, diagrams illustrating a graphical user interface (GUI) 300 that may be displayed to one or more users viewing an icebreaker message is shown. The GUI 300 may be used to execute, at least, step 106 and step 108 as described above with reference to FIG. 1.

FIG. 3A shows an icebreaker message 302 displayed in a user's stream 304. The icebreaker message 302 may include icebreaker message text 306 and optionally an image 308. The icebreaker message 302 may include a reply field 310 and a send button 312.

FIG. 3B shows a user filing in the reply field 310 of the icebreaker message 302. The reply field 308 may display any input entered by the user into an input device 312. As shown in FIG. 3B, the input device 312 may include an on-screen keyboard. The user may enter any input into the reply field 308, including, but not limited to, text, numbers, symbols, emoji, and Graphical Interchange Format (GIF) images. Here, the input is text that reads “I am eternally happy . . . .” The user may then click send 310 to reply to the icebreaker message 302 and initiate a private one-on-one chat with the poster.

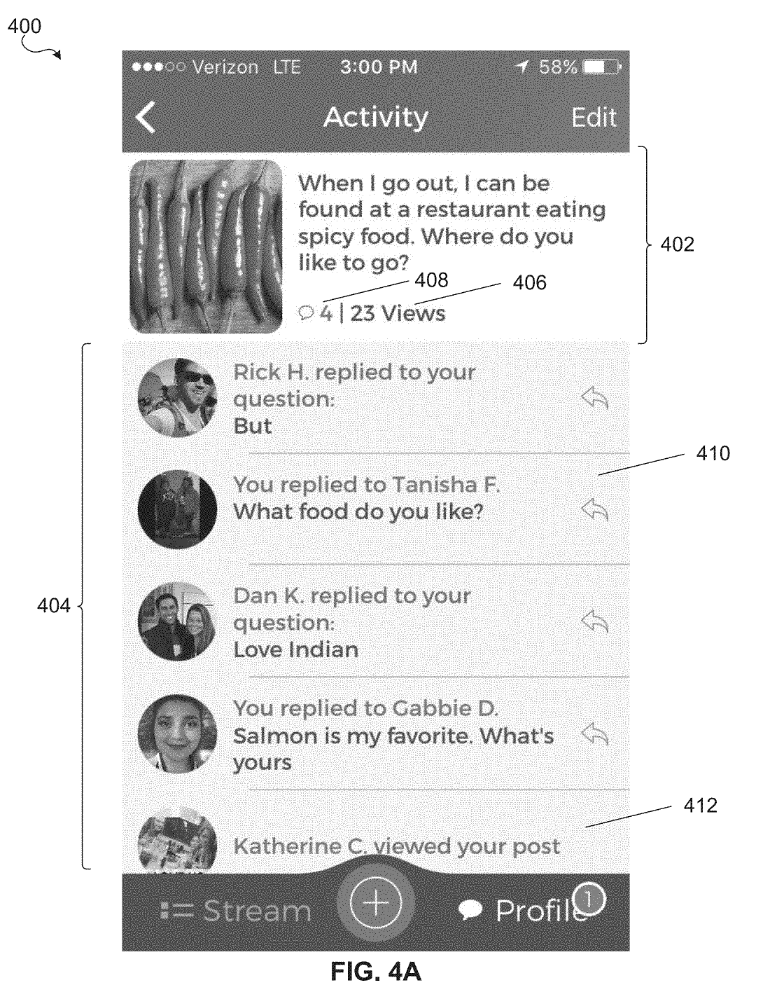

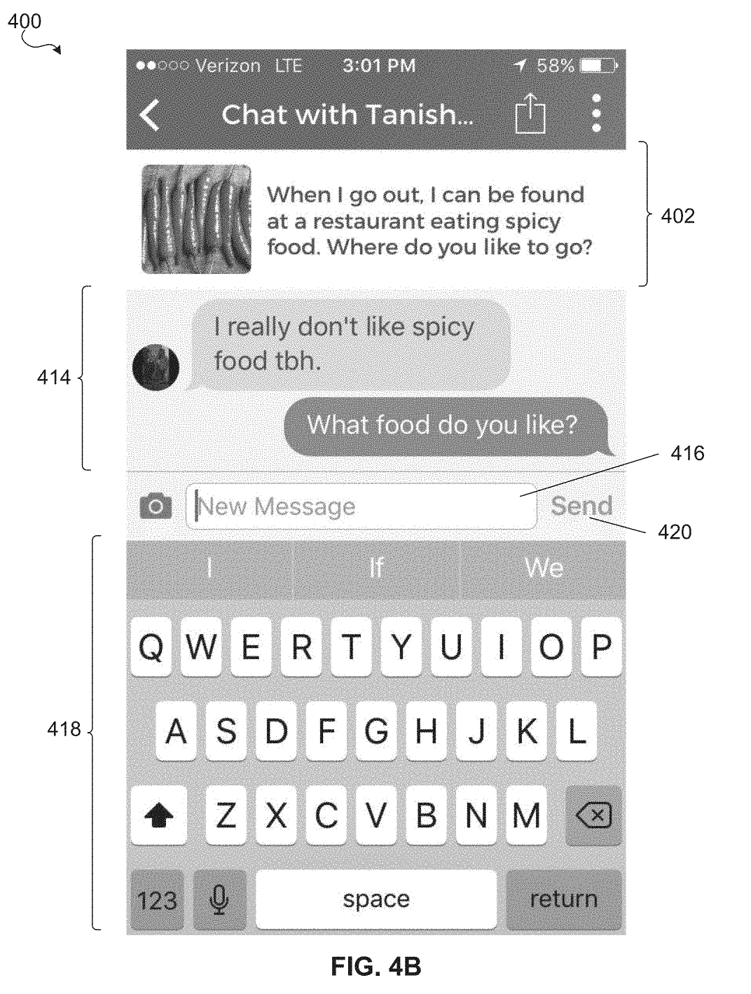

Referring now to FIGS. 4A-4B, diagrams illustrating a graphical user interface (GUI) 400 that may be displayed to the poster after receiving one or more replies to an icebreaker message is shown. The GUI 400 may be used to execute, at least, step 110 and step 112 as described above with reference to FIG. 1.

FIG. 4A shows an icebreaker message 402 posted by the poster as well as one or more indicators 404. As described above, the icebreaker message 402 may include a view counter 406 and a reply indicator 408. The one or more indicators 404 may be aggregated on one screen displayed to the poster. The one or more indicators may include a reply notification 410 or a view notification 412 depending how one or more users interact with the icebreaker message 402. Each of the one or more indicators 404 may only be visible to the poster. In other words, a user “Rick H.” cannot see and does not know that a user “Tanisha F.” has also replied to the icebreaker message 402 or that a user “Katherine C.” viewed the icebreaker message, and vice versa. The reply notification 410 initiates a private one-on-one chat with the poster and the user that replied to the icebreaker message 402. The one or more indicators may show the latest items at the top, and the entries may move down as time goes by.

FIG. 4B shows a private one-on-one chat 414 with the user “Tanisha F.” that replied to the icebreaker message 402. The private one-on-one chat 414 may include a chat field 416 that displays any input entered by the user into an input device 418. As shown in FIG. 4B, the input device 418 may include an on-screen keyboard. The user may enter any input into the chat field 416, including, but not limited to, text, numbers, symbols, emoji, and Graphical Interchange Format (GIF) images. The poster may then click send 4200 to send a message to the user.

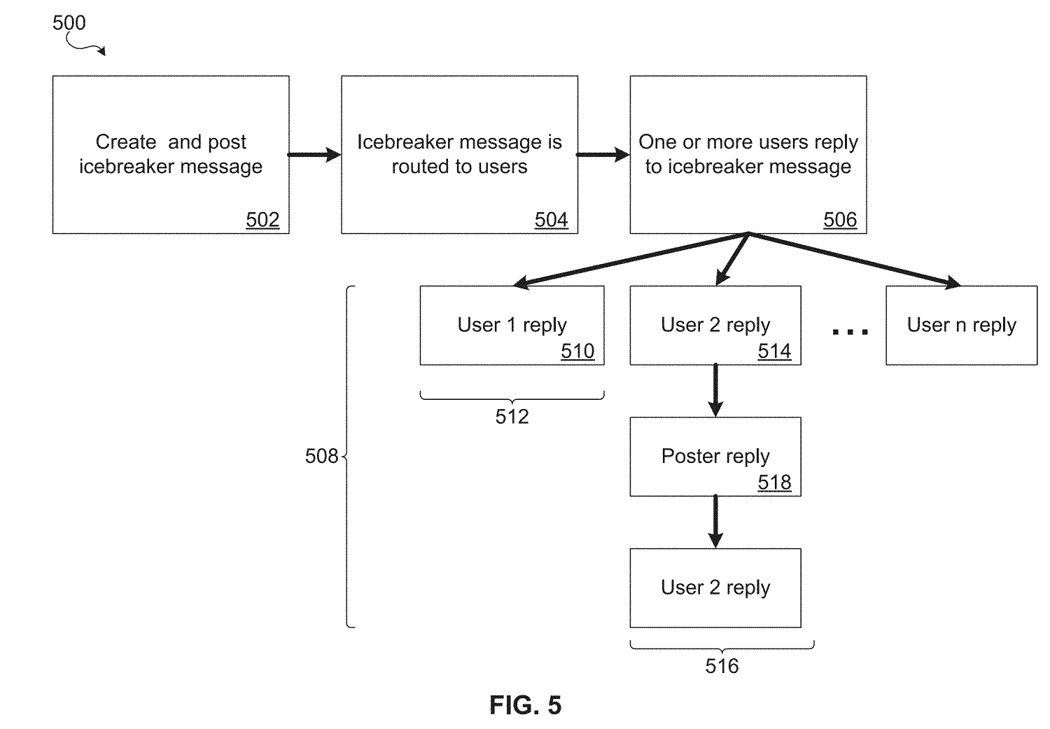

Referring now to FIG. 5, a block diagram 500 illustrating the creation of private one-on-one chat threads based on replies to a public icebreaker message is shown. In block 502, a poster may create a post an icebreaker message. As described above, the poster may use a fill-in-the-blank template to create icebreaker message text. The poster may include an image in the icebreaker message. The poster may submit the icebreaker message to be posted publicly.

In block 504, the icebreaker message may be routed to one or more users, such that it is displayed in their stream. The routing may be based on one or more variables, including but not limited to, timing of previous posts, and the age, location, and/or gender of the poster and/or users.

In block 506, one or more users may reply to the icebreaker message by replying directly to the message. Each reply may initiate a private one-on-one chat thread 508 between each user that replies and the poster. For example, a first user may reply in block 510, creating a first one-on-one chat thread 512. The poster may choose to reply to the first user's reply 510 or ignore it. A second user may reply in block 514, creating a second one-on-one chat thread 516. The poster may reply in block 518, and the second one-on-one chat thread 516 may continue.

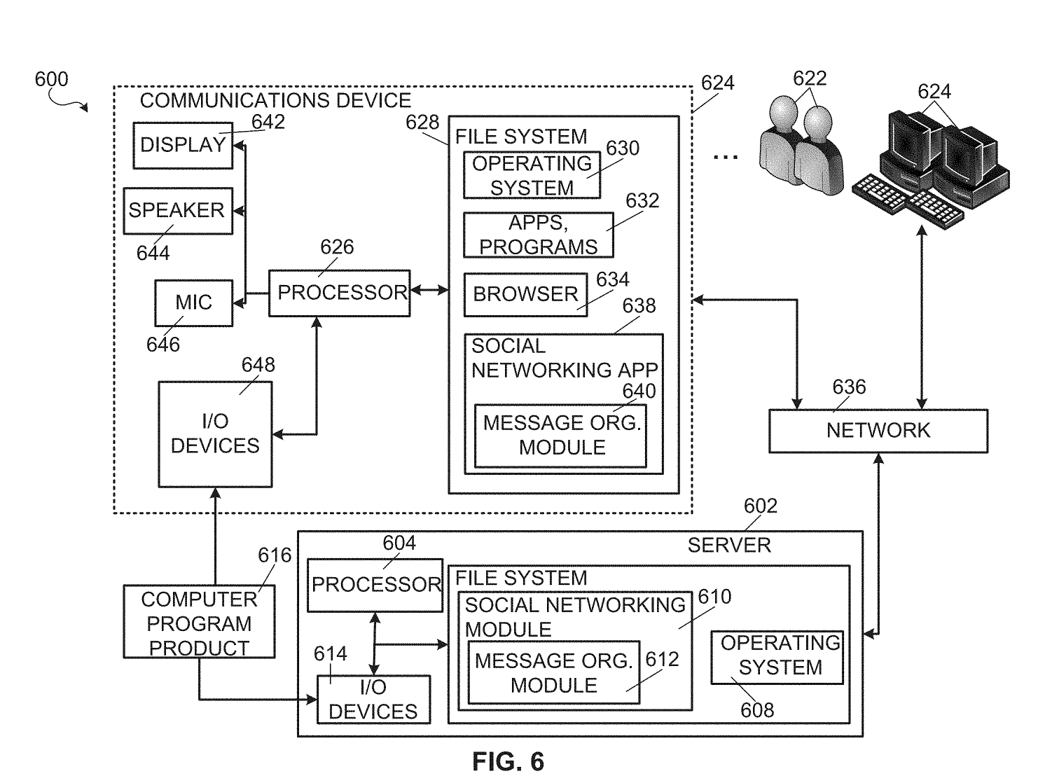

FIG. 6 is a block schematic diagram of a system 600 configured for organizing messages based on user response to a one-to-many icebreaker post. The methods described above may be embodied in and performed by the system 600. The system 600 may include a server 602. The server 602 may include a processor 604 for controlling operation of the server 602 and for performing functions, such as those described herein with respect to filtering and sorting messages of a social network. The server 602 may be connected to a network 636 via an interface.

The server 602 may also include a file system 606 or memory. An operating system 608, applications, and other programs may be stored on the file system 606 for running or operating on the processor 604. A social networking module 610 or system may also be stored on the file system 606 and may be compiled and run on the processor 604 to perform the functions for organizing messages of a social network as described herein. The methods described above may be embodied in the social networking module 610 and may be performed by the processor 604 when the social networking module 610 is compiled and run on the processor 604.

The social networking module 610 may provide the functions of the social media application as described above. The social networking module 610 may include a message organizing module 612 for organizing message of the social network as described herein. In another embodiment, the message organizing module 612 may be separate from the social networking module 610 and may operate in coordination with the social networking module 610 to perform the operations described herein. As described above, the message organizing module 612 may be configured to organize the messages of a social network by filtering and sorting the messages based on the methods described above.

For example, the message organizing module 612 may receive a completed icebreaker message 230 from a poster as described above with reference to FIGS. 2A-2H. The message organizing module 612 may publicly broadcast the completed icebreaker message 230 so that it may be seen by multiple users 622 of the social network. The social networking module 610 and the message organizing module 612 may route the completed icebreaker message 230 to a subset of users 622 based on one or more variables including, but not exclusive to, recent posts, gender, age, location and preferences. One or more users 622 may view the completed icebreaker message 230 on a local communications device 624.

The message organizing module 612 may receive an indication that a user 622 has viewed the completed icebreaker message 230. The message organizing module 612 may provide the poster with an indication that a user viewed the completed icebreaker message 230. The indication may only be provided to the poster and may only be visible to the poster. The message organizing module 612 may receive a reply to the completed icebreaker message from a first user of the one or more users 622. The message organizing module 612 may provide the reply to the poster and initiate a private one-on-one chat thread with the poster and the first user. The messaging organizing module 612 may receive and send subsequent messages from the poster and the first user in the one-on-one chat. The message organizing module 612 may repeat this process for each subsequent user that replies to the completed icebreaker message 230.

The server 602 may also include one or more input devices, output devices or combination input/output devices, collectively I/O devices 614 in FIG. 6. The I/O devices 614 may include, but are not necessarily limited to, a keyboard or keypad, a pointing device such as a mouse, a disk drive and any other devices to permit a user to interface with and control operation of the server 602 and to access the social networking module 610 or system. At least one of the I/O devices 614 may be a device to read a computer program product, such as a computer program product 616. The computer program product 616 may be similar to those described above. The social networking module 610 may be loaded on the file system 606 from the computer program product 616.

A user 622 of a social network, such as the poster and the one or more users, may use a communications device 624 to access the server 602 and social networking module 610. The communications device 624 may be a mobile or handheld computer or communications device. The communications device 624 may include a processor 626 to control operation of the communications device 624 and a file system 628, memory, or similar data storage device. An operating system 630, applications 632, and other programs may be stored on the file system 628 for running or operating on the processor 626. A web or Internet browser 634 may also be stored on the file system 628 for accessing the server 602 or server via the network 636 over an interface. The network 636 may be the Internet, an intranet or other private or proprietary network.

Additionally or alternatively, a social networking application 638, feature or module may also be stored on the file system 628 and may operate on the processor 626 of the user's communications device 624. The social networking application 638 may include a message organizing module 640 for organizing messages of the social network, in which the user 322 is a member. The message organizing module 640 may be a separate module from the social networking application 638 and may operate in cooperation with the social networking application 638 to perform the functions described herein. The message organizing module 640 may send the completed icebreaker message 230 to the message organizing module 612 as well as replies to one-on-one chats. The message organizing module 640 may receive view indications, initiations of one-on-one chats, and replies to one-on-one chats from the message organizing module 612.

The social networking application 638 operating on the computer system 626 may interface with or operate in conjunction with the social networking module 610 or system on the server 602 to perform the functions and operations described herein for organizing social media messages. Accordingly, the social networking application 638 operating on the communications device 624 may perform some of the functions and operations of the methods described above and the social networking module 610 operating on the server 602 may perform other functions of the methods. Embodiments may include only the social networking module 610 on the server 602, only the social networking application 638 on the client communications device 624, or both.

The communications device 624 may also include a display 642, a speaker system 644, and a microphone 646 for voice communications. One or more user interfaces may be presented on the display 642 for controlling operating the social networking module 610 and social networking application 638. For example, the display 642 may show one or more of the GUIs described above with reference to FIGS. 2A-4B.

The communications device 624 may also include one or more input devices, output devices, or combination input/output devices, which may be collectively referred to as I/O devices 648. The I/O devices 648 may include a keyboard or keypad, pointing device such as a mouse, disk drives, and any other devices to permit the user 622 to interface with and control operation of the communications device 624. The I/O devices 648 may allow the user 622 to access the social networking application 638 and social networking module 610 or system on the server 602. The I/O devices 648 may also include at least one device configured to read computer code from a computer program product, such as the computer program product 616.

The flowcharts and block diagrams above illustrate the architecture, functionality, and operation of possible implementations of systems, methods, and computer program products according to various embodiments. In this regard, each block in the flowchart or block diagrams may represent a module segment, or portion of instructions, which comprises one or more executable instructions for implementing the specified logical functions.

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “include” and/or “includes” specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to embodiments in the form disclosed. Modifications and variations may be apparent to those of ordinary skill in the art without departing from the scope and spirit of embodiments of the invention.

What is claimed is:

1. A method of organizing messages in a social media application, the method comprising:
receiving, by a processor, an icebreaker message from a poster;
broadcasting, by the processor, the icebreaker message to a plurality of users of the social media application;
receiving, by the processor, a reply to the icebreaker message from a first user of the plurality of users, wherein the reply is made directly to the icebreaker message and is not visible to the remaining plurality of users;
sending, by the processor, the reply to the poster; and
initiating, by the processor, a private one-on-one chat thread between the poster and the first user.

2. The method of claim 1, wherein the icebreaker message comprises a message text generated after the poster fills in a blank of a prompt using an input device.

3. The method of claim 1, wherein the icebreaker message comprises an image uploaded by the poster.

4. The method of claim 1, wherein the icebreaker message is available to all users of the social media application.

5. The method of claim 1, further comprising:
routing, by the processor, the icebreaker message to the first user based on one or more variables.

6. The method of claim 5, wherein the one or more variables comprise one or more of recent posts, gender, age, location, and preferences.

7. The method of claim 1, further comprising:
receiving, by the processor, an indication that the first user viewed the icebreaker post; and
sending, by the processor, the indication to the poster.

8. The method of claim 1, wherein the broadcasted icebreaker message comprises a reply field for the plurality of users to directly enter a reply.

9. The method of claim 1, wherein the reply comprises text entered by an input device.

10. The method of claim 1, wherein the reply comprises an image uploaded by the first user.

11. A server for organizing messages in a social media application, the server comprising:
a processor configured to receive an icebreaker message from a poster;
the processer further configured to broadcast the icebreaker message to a plurality of users of the social media application;
the processer further configured to receive a reply to the icebreaker message from a first user of the plurality of users, wherein the reply is made directly to the icebreaker message and is not visible to the remaining plurality of users;
the processer further configured to send the reply to the poster; and
the processer further configured to initiate a private one-on-one chat thread between the poster and the first user.

12. The server of claim 11, wherein the icebreaker message comprises a message text generated after the poster fills in a blank of a prompt using an input device.

13. The server of claim 11, wherein the icebreaker message comprises an image uploaded by the poster.

14. The server of claim 11, wherein the icebreaker message is available to all users of the social media application.

15. The server of claim 11, wherein the processor is further configured to:
route the icebreaker message to the first user based on one or more variables.

16. The server of claim 15, wherein the one or more variables comprise one or more of recent posts, gender, age, location, and preferences.

17. The server of claim 11, wherein the processor is further configured to:
receive an indication that the first user viewed the icebreaker post; and
send the indication to the poster.

18. The server of claim 11, wherein the broadcasted icebreaker message comprises a reply field for the plurality of users to directly enter a reply.

19. The server of claim 11, wherein the reply comprises text entered by an input device.

20. The server of claim 11, wherein the reply comprises an image uploaded by the first user.
